(19) United States
(12) Patent Application Publication
(10) Pub. No.: US 2014/0367026 A1
(43) Pub. Date: Dec. 18, 2014

(54) KIT AND METHOD FOR THE TEMPORARY ATTACHMENT OF AN ELECTRONIC DEVICE TO A SUPPORT OF A TYRE CASING

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Claudio Battocchio, Clermont-Ferrand Cedex 9 (FR); Thierry Penot, Clermont-Ferrand Cedex 9 (FR); Pierre Voissier, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/349,762

(22) PCT Filed: Oct. 4, 2012
(86) PCT No.: PCT/FR2012/052250

§ 371 Date: Apr. 4, 2014

(30) Foreign Application Priority Data
Oct. 5, 2011 (FR) 1158987

(51) Int. Cl. B29D 30/00; B29D 30/54

(52) U.S. Cl. CPC B29D 30/0061; B29D 30/54; B29D 2030/546
USPC 156/95; 156/60; 428/36.8; 428/41.7; 428/343

(57) ABSTRACT

A kit, which is usable for temporary attachment of an electronic device to a support of a tyre casing, includes: an attachment member and a separation element. The attachment member includes an adhesive mass for attaching the electronic device to the support. The separation element, which separates the adhesive mass from the support, is able to adhere to the adhesive mass. An adhesion between the adhesive mass and the separation element exceeds an adhesion between the adhesive mass and the support as a function of a variation of at least one parameter of the adhesive mass.

The present invention relates to the domain of tyre casings. More specifically, it concerns the domain of monitoring tyre casings during tyre casing processing methods, in particular retreading methods.

The term “tyre casing” used below refers to a raw tyre blank, a new or worn vulcanized tyre, a tyre structure being retreaded or a retreaded tyre. The invention applies to all types of tyre casings, in particular those designed to be fitted to passenger vehicles, sports utility vehicles (SUV), two-wheeled vehicles (in particular motorcycles), aeroplanes, industrial vehicles including vans, heavy goods vehicles such as metro trains, buses, heavy road transport vehicles (trucks, tractors, trailers), off-road vehicles such as agricultural or engineering vehicles, or other transport or maintenance vehicles.

The casing is usually processed at an appropriate site. The casing is therefore sent to the processing site, processed at this site, then shipped back to the usage site. It is desirable to track and monitor each casing during processing. For this purpose, an electronic identification device is attached to the casing during receipt of the casing and removed from the casing before said casing is dispatched. A temporary device attachment method is known from the prior art in which the device is attached to the casing by means of a belt positioned in a meridian plane of the casing, enabling the device to be pressed against an internal surface of the casing.

However, this temporary attachment method is relatively complex and costly. Furthermore, several belts of different sizes are required for different casing dimensions.

The invention is therefore intended to enable temporary attachment that is simpler and cheaper.

For this purpose, the invention relates to a kit for the temporary attachment of an electronic device to a support for a tyre casing comprising:
an attachment member comprising an adhesive mass for attaching the electronic device to the support,
a separation element for separating the adhesive mass from the support that is able to adhere to the adhesive mass,
the adhesion between the adhesive mass and the separation element becoming greater than the adhesion between the adhesive mass and the support as a function of the variation of at least one parameter of the adhesive mass. This adhesion (adhesion force) is understood in consideration of the interposition of the electronic device, which can reduce the adhesion surface with the separation element.

The kit according to the invention enables reliable monitoring of the casing. Indeed, the electronic device can perform the functions of identifying the casing, reading and/or writing data relating to the processing method and/or to the casing, etc. The adhesive mass enables the device to be attached simply and quickly to the support of the casing by adhesion and obviates the need to use the belt attachment in the prior art. Furthermore, the adhesive mass is not dependent on the size of the casing. Finally, the elements of the kit are not costly, enabling the casing to be monitored cheaply.

Furthermore, if the value of the parameter is selected such that the adhesion between the adhesive mass and the separation element is greater than the adhesion between the adhesive mass and the support, the device and the adhesive mass can be removed without damaging the casing. If the value of the parameter is selected such that the adhesion between the adhesive mass and the support is greater than the adhesion between the adhesive mass and the separation element, the device is attached to the support of the casing and the risk of the casing being unidentifiable if the adhesive mass becomes accidentally detached is obviated.

Preferably, the attachment member includes two films intended to protect the adhesive mass between which the adhesive mass is inserted.

In one embodiment, the adhesion between the adhesive mass and the support is greater than the adhesion between the adhesive mass and at least one of the protective films.

In another embodiment, the adhesion between the adhesive mass and the separation element is greater than the adhesion between the adhesive mass and at least one of the protective films.

In one embodiment, the kit includes an electronic device.

In one embodiment, the separation element adheres to an adhesion surface of the adhesive mass between the adhesive mass and the electronic device, and the electronic device is held by the adhesive mass and is inserted between the separation element and the adhesion surface between the adhesive mass and the electronic device.

Optionally, the attachment member includes a protective film for the adhesive mass adhering to an adhesion surface of the adhesive mass between the adhesive mass and the support.

Such a kit is easy to use, for example during the processing method. Indeed, the protective film is simply removed from the adhesive mass to use the kit.

The invention also relates to a tyre casing having an adhesive mass and a separation element from a kit such as the one described above, the adhesive mass adhering to a support of the casing.

Preferably, the support includes an internal rubber ply.

The invention also relates to a method for temporarily attaching an electronic device to a support of a tyre casing, using a kit such as the one described above, in which:
the adhesive mass is adhered to the support,
the electronic device is held by the adhesive mass,
the separation element is adhered to the adhesive mass,
the parameter of the adhesive mass is altered such that the adhesion between the adhesive mass and the separation element exceeds the adhesion between the adhesive mass and the support,
the unit formed by the electronic device, the adhesive mass and the separation element is separated from the support of the tyre casing by pulling on the separation element.

Preferably, the adhesive mass is entirely covered by the separation element. The separation element firstly helps to protect the electronic device during the method and secondly helps to protect the elements liable to come into contact with the device or with the adhesive mass during this method. Thus, for example, during a retreading method, the separation element helps to protect the curing membrane of the mould in which the tyre casing is vulcanized.

In one embodiment:
a protective film is removed from the attachment member such as to expose an adhesion surface of the adhesive mass between the adhesive mass and the support,
the adhesion surface between the adhesive mass and the support is adhered to the support,
the other protective film is removed from the attachment member such as to expose an adhesion surface of the adhesive mass between the adhesive mass and the electronic device,

In another embodiment:
a protective film is removed from the attachment member such as to expose an adhesion surface of the adhesive mass between the adhesive mass and the electronic device,
the electronic device is adhered to the adhesion surface between the adhesive mass and the electronic device,
the separation element is adhered to the adhesion surface between the adhesive mass and the electronic device,
the other protective film is removed from the attachment member such as to expose an adhesion surface of the adhesive mass between the adhesive mass and the support,
the adhesion surface between the adhesive mass and the support is adhered to the support.

Advantageously, the parameter is the temperature of the adhesive mass.

Preferably, adhesion between the adhesive mass and the separation element exceeds the adhesion between the adhesive mass and the support when the temperature of the adhesive mass is greater than a predetermined temperature threshold. Typically, the temperature (T) of the adhesive mass (78) is kept above the predetermined temperature threshold (T2) before the unit formed by the electronic device (62), the adhesive mass (78) and the separation element (84) is separated from the support (40) of the tyre casing (10).

The invention also relates to a method for processing a tyre casing comprising the following steps:
an electronic device is attached temporarily to a support of the tyre casing using a method such as the one described above, and
the tyre casing undergoes a method during which the parameter (T) of the adhesive mass (78) is altered such that the adhesion between the adhesive mass (78) and the separation element (84) exceeds the adhesion between the adhesive mass (78) and the support (40);
the unit formed by the electronic device, the adhesive mass and the separation element is separated after the processing step.

Advantageously, as the tyre casing comprises a structure and a worn tread, during the processing step:
the worn tread is removed,
a new raw tread is attached to the structure,
the unit comprising the structure and the new raw tread is vulcanized in a vulcanization mould.

If the tread of the casing is worn, the casing is retreaded so that the structure can be reused, provided it is not so worn that it has to be replaced. During retreading, the device is attached temporarily and enables the structured to be monitored between receipt and dispatch thereof. Monitoring is in particular intended to ensure that the structure dispatched following retreading is indeed the structure that was received.

The invention can be better understood from the description given below, provided exclusively as a non-limiting example, with reference to the drawings, in which:

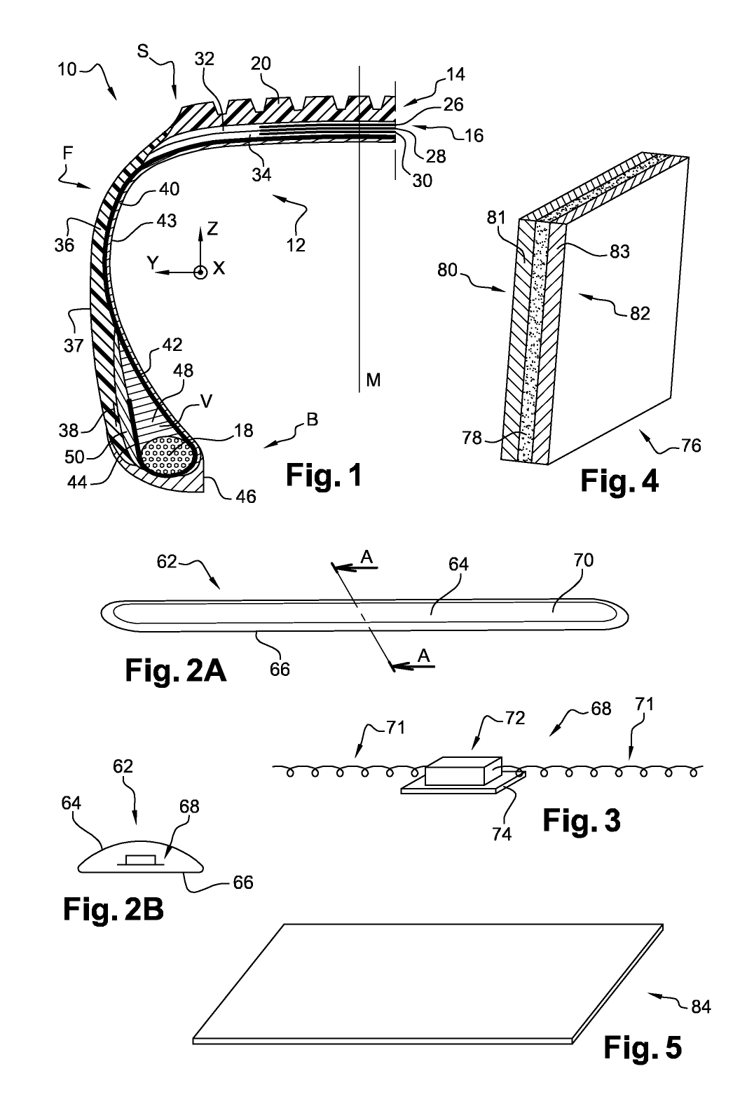

FIG. 1 is a radial cross section of a tyre casing with a new tread;

FIG. 2A is a perspective view of an electronic device from a kit according to the invention;

FIG. 2B is a cross section of the device in FIG. 2A along the line A-A;

FIG. 3 is a perspective view of an electronic member of the device in FIGS. 2A and 2B;

FIG. 4 is a perspective view of an attachment member from the kit according to the invention;

FIG. 5 is a perspective view of a separation element from the kit according to the invention;

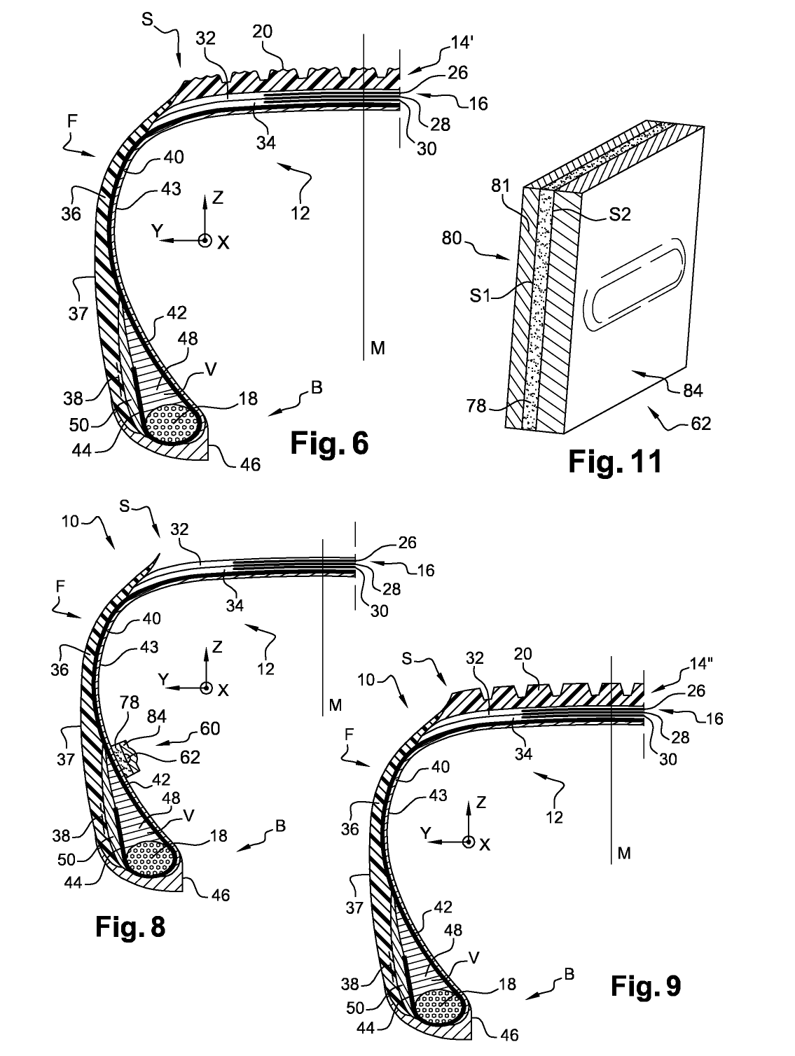

FIG. 6 is a radial cross section of the tyre casing in FIG. 1, in which the tread is worn;

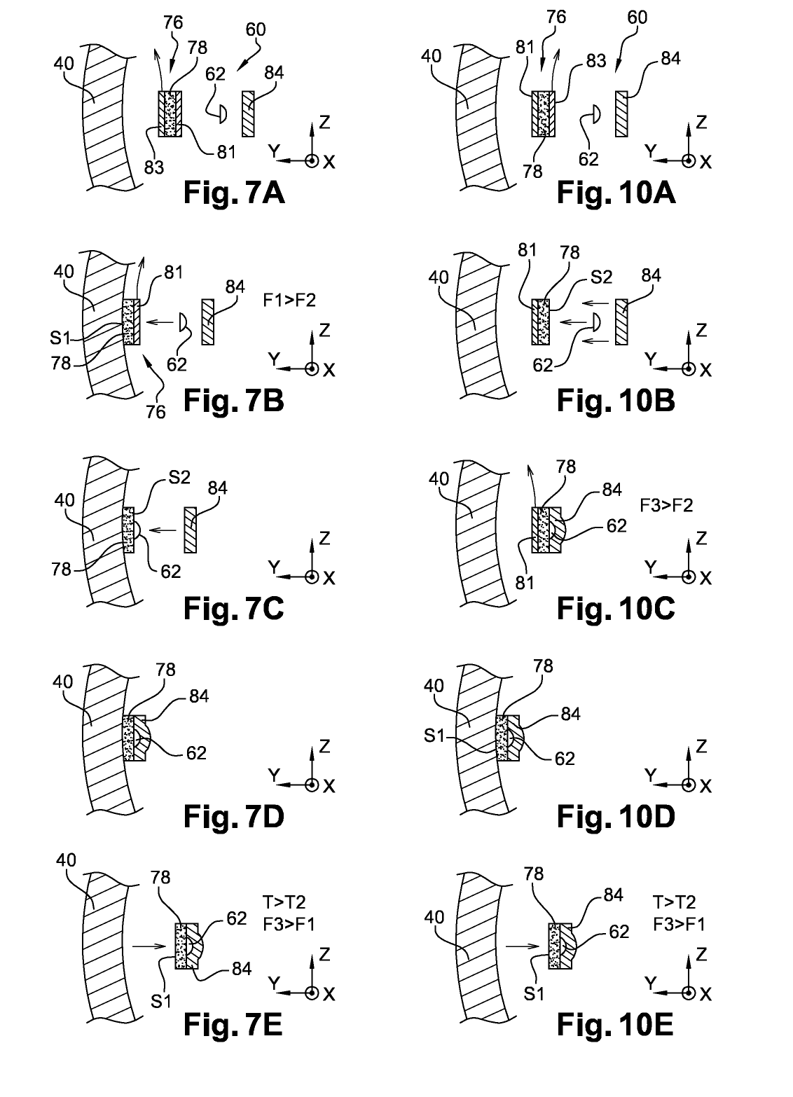

FIGS. 7A to 7E show the steps of a method for temporarily attaching the device in FIGS. 2A and 2B according to a first embodiment of the invention during a processing method of the tyre casing in FIG. 6;

FIG. 8 is a view similar to the view in FIG. 6 of the tyre casing, from which the worn tread has been removed;

FIG. 9 is a view similar to the view in FIG. 6 of the tyre casing in FIG. 8 with a new tread;

FIGS. 10A to 10E show the steps of a method for temporarily attaching the device in FIGS. 2A and 2B according to a second embodiment of the invention during a processing method of the tyre casing in FIG. 6;

FIG. 11 shows a kit according to a variant of the invention.

FIGS. 1 and 6, 7A to 7E, 8, 9 and 10A to 10E show the mutually orthogonal axes X, Y, Z according to the normal circumferential (X), axial (Y) and radial (Z) orientations of a tyre casing.

FIG. 1 shows a tyre casing indicated using the general reference sign 10. In this case, the tyre casing 10 is intended to be assembled on a wheel of a heavy goods vehicle.

The tyre casing 10 is a tyre comprising a structure 12 and a new tread 14.

The structure 12 includes a central reinforcement 16 prolonged by two sidewalls F and two beads B. A single sidewall F and a single bead B are shown in the figures. The tread 14 and the central reinforcement 16 of the structure 12 form a crown S of the tyre casing 10.

Two bead cores 18 (only one shown) are embedded in the beads B. The two bead cores 18 are arranged symmetrically in relation to a median radial plane M of the tyre casing. Each bead core 18 revolves about a reference axis. This reference axis, substantially parallel to the direction Y, substantially matches an axis of revolution of the tyre casing 10.

The tread 14 includes patterns 20. The reinforcement 16 includes metal plies 26, 28 and 30 embedded in the rubber masses 32 and 34. A rubber mass 36 extends radially from the crown as far as the bead core 18 of the bead B, delimiting an external surface 37 of the sidewall F and of the bead B. Moreover, in the example described, the bead B includes an annular ply 38 comprising metal reinforcers inclined in relation to the circumferential direction.

The tyre casing 10 also has an airtight inner rubber ply 40 as well as a carcass ply 42. These plies 40 and 42 are usually toroidal and are both coaxial to the bead cores 18. The plies 40 and 42 extend between the two annular bead cores 18 of the tyre casing 10 via the crown S. The ply 40 has an inner surface 43 designed to be in contact with the air contained in the casing.

The bead B also includes an annular protective rubber mass 46 intended to enable the partial radial and axial engagement of the tyre casing 10 with a rim. The bead B of the tyre casing 10 also includes rubber masses 48, 50 used to pack a volume between the carcass ply 42 and the mass 36.

FIGS. 2A, 2B and 3 to 5 show different elements of a kit for temporarily attaching an electronic device to a support of the casing 10. The kit is identified by the general reference sign 60.

FIGS. 2A and 2B show an electronic identification device 62 from the kit 60. The electronic device 62 has an overall elongated shape that is 60 mm long and 13 mm wide. The device 62 includes an electronic member 68 coated with a vulcanized rubber mass 70 that is preferably insulating. The rubber mass 70 is delimited by a convex surface 64 opposite a flat surface 66. Alternatively, the electronic member 68 of the device 62 is uncoated, i.e. not rubber coated.

FIG. 3 shows the electronic member 68. The member 68 has two antennas 71 and a microchip 72. The member 68 also has a support 74 for the chip 72. The chip 72 has a passive radio-frequency identification (RFID) transponder operating at 868 MHz. The two antennas 71 form a dipole antenna.

FIG. 4 shows a member 76 for attaching the device 62 to the casing 20. The member 76 has an overall rectangular shape 25 mm wide and 75 mm long. The member 76 includes an adhesive mass 78 for attaching the device 62 to a support, in this case the ply 40. The mass 78 forms a layer between two films 80, 82 protecting the mass 78. The layer of the mass 78 is thicker than 30 μm, and preferably between 40 and 100 μm. Preferably, as the adhesive mass 78 is insulating, operation of the electronic device is improved. The film 80 includes a sheet 81 for supporting and protecting the mass 78. The sheet 81 has a very smooth surface and is made of glazed paper coated with polytetrafluoroethylene (PTFE) or polyethylene (PE). The film 82 includes a sheet 83 for protecting the mass 78.

The adhesive in the mass 78 is a pressure-sensitive adhesive. Preferably, the adhesive includes at least one acrylic polymer, for example based on polybutyl acrylate, and/or at least one acrylic copolymer, for example based on isooctyl acrylate/acrylic acid. In this case, the adhesive is more than 50% polymer and/or copolymer by total adhesive mass, and preferably more than 75% and more preferably more than 90%. Such a pressure-sensitive adhesive is sufficiently tacky to obviate the need for an additional tackifier.

The kit 60 also includes an element 84 for separating the mass 78 from the support 40, as shown in FIG. 5. The element 84 is able to adhere to the adhesive mass 78 and has a general rectangular shape more than 25 mm wide and more than 75 mm long. Such dimensions enable the element 84 to fully cover the mass 78. The element 84 is made of greaseproof paper or PTFE. The separation element is able to withstand temperatures exceeding 200° C.

The adhesion F1 between the adhesive mass 78 and the support 40 is greater than the adhesion F2 between the adhesive mass 78 and at least one of the protective films 80, 82, in this case the film 80.

The adhesion F3 between the adhesive mass 78 and the separation element 84 is greater than the adhesion F2 between the adhesive mass 78 and at least one of the protective films 80, 82, in this case the film 80.

The adhesion F3 between the adhesive mass 78 and the separation element 84 exceeds the adhesion F1 between the adhesive mass 78 and the support 40 as a function of the variation of one parameter of the adhesive mass 78, in this case the temperature T of the mass 78. In this case, when the temperature T of the adhesive mass 78 is greater than a predetermined temperature threshold T2, the adhesion F3 between the mass 78 and the separation element 84 is greater than the adhesion F1 between the mass 78 and the support 40. T2 is greater than or equal to 100° C. and preferably greater than or equal to 120° C.

The main steps of a processing method according to the invention, in this case a retreading method, are described below with reference to FIGS. 6, 7A-7E, 8 and 9. During the retreading method, the device 62 is temporarily attached to the support 40 of the tyre casing 10 by means of the steps of a first embodiment of a temporary attachment method.

FIG. 6 shows the tyre casing 10 in FIG. 1 after it has travelled many kilometres. The tyre casing 10 thus has a worn tread 14′.

When the casing 10 is received at the retreading site, the inner surface 43 of the ply 40 is cleaned, for example using a cleaning liquid such as the one marketed as Tyre Cleaner© 16-471 by the company Patch Rubber. The envelope and the kit 60 shown in FIG. 7A are obtained.

The protective sheet 83 is then removed from the member 76 such as to expose an adhesion surface S1 between the adhesive mass 78 and the support 40.

The adhesion surface S1 of the adhesive mass 78 is then adhered to the support 40. The adhesion step is preferably performed using an application template. To ensure optimal adhesion of the mass 78, the sheet 81 is rolled with a roller The casing shown in FIG. 7B is obtained.

The sheet 81 is then removed from the member 76 such as to expose an adhesion surface S2 between the adhesive mass 78 and the electronic device 62.

The device 62 is then held by the mass 78. In this case, the electronic device 62 is adhered to the adhesion surface S2 of the adhesive mass 78. The device 62 is positioned such that the flat surface 66 is in contact with the mass 78. The device 62 is pushed down to remove any air trapped between the device 62 and the mass 78, pushing from the centre towards the edges of the device 62. The casing shown in FIG. 7C is obtained.

The separation element 84 is then adhered to the mass 78 such that the element 84 fully covers the mass 78. The casing shown in FIG. 7D is then obtained, comprising the separation element 84, the device 62 and the adhesive mass 78 adhering to the support 40 of the envelope 10, in this case to the internal surface 43 of the ply 40 towards the bottom of the casing.

The casing 10 is then processed.

The worn tread 14′ is removed. The casing 10 according to the invention as shown in FIG. 8 comprising the structure 12 is obtained.

A new raw tread 14″ is then attached to the structure 12. In this case, the new raw tread 14″ is laid on the reinforcement 16. The casing including the structure 12 and the tread 14″ are then positioned in a vulcanization mould incorporating a curing membrane (not shown) and the casing is vulcanized.

The casing is removed from the mould after vulcanization. The temperature T of the adhesive mass 78 is then such that the adhesion F3 between the adhesive mass 78 and the separation element 84 exceeds the adhesion F1 between the adhesive mass 78 and the support 40. In this case, the mass 78 is kept at a temperature T greater than T2, in this case 105° C. and preferably 125° C. The unit comprising the electronic device 62, the mass 78 and the element 84 is then separated from the ply 40 by pulling on the element 84, as shown in FIG. 7E. The mass 78 is then entirely separated from the ply 40 and no trace of the mass 78 remains on the ply 40.

The casing shown in FIG. 9 comprising the structure 12 and the new vulcanized tread 14″ is obtained.

The main steps of a processing method according to the invention, in this case a retreading method, are described below with reference to FIGS. 6, 8, 9 and 10A-10E. During the retreading method, the device 62 is temporarily attached to the support 40 of the tyre casing 10 by means of the steps of a second embodiment of a temporary attachment method. The elements similar to those in the preceding figures are indicated using the same reference signs.

During the temporary attachment method, the sheet 83 is removed from the member 76, as shown in FIG. 10A, such as to expose the adhesion surface S2 between the adhesive mass 78 and the electronic device 62.

The electronic device 62 and the separation element 84 are then adhered to the adhesion surface S2 of the adhesive mass 78 such that the element 84 fully covers the mass 78. The casing shown in FIG. 10C is obtained.

The protective sheet 81 is then removed from the member 76 such as to expose the adhesion surface S1 between the adhesive mass 78 and the support 40.

Finally, the adhesion surface S1 is adhered to the support 40. The casing shown in FIG. 10D is obtained.

The remainder of the method is the same as in the first embodiment.

One of the advantages related to the invention and in particular the use of the temporary attachment method as part of a retreading method is that the kit according to the invention prevents the internal airtight rubber ply of the envelope from being damaged. Indeed, since the adhesive mass can be removed easily at an appropriate parameter value, there is no need to subject the internal airtight rubber ply to mechanical stresses that could damage it in order to remove the electronic device.

FIG. 11 shows a variant of the kit 60 shown in an assembled, ready-to-use form. This variant is also shown in FIG. 10C. The attachment member 76 includes the protective film 80 adhered to the adhesion surface S1. The separation element 84 adheres to the adhesion surface S2 of the adhesive mass 78. The electronic device 62 is held by the adhesive mass 78, in this case adhering to the adhesion surface S2 and inserted between the separation element 84 and the surface S2.

In this variant, the adhesion between the adhesive mass 78 and the separation element 84 is greater than the adhesion between the adhesive mass 78 and the protective film 80. Furthermore, as above, the adhesion between the adhesive mass 78 and the separation element 84 exceeds the adhesion between the adhesive mass 78 and the support 40 as a function of the variation of at least one parameter T of the adhesive mass 78.

The invention is not limited to the embodiments described above. Indeed, the electronic device could be attached to the support of the casing by inserting the device between the support and the adhesive mass. Furthermore, the adhesive mass could be applied to the support by spraying, without using a mass provided between two films as in the attachment member 76.

Furthermore, the electronic device 62 could be temporarily attached to the support 40 of the tyre casing 10 during a processing method other than a retreading method, such as a method for manufacturing the tyre casing.

1-15. (canceled)

16. A kit for temporary attachment of an electronic device to a support for a tyre casing, the kit comprising:
an attachment member that includes an adhesive mass for attaching the electronic device to the support; and
a separation element for separating the adhesive mass from the support, the separation element being able to adhere to the adhesive mass,
wherein an adhesion between the adhesive mass and the separation element becomes greater than an adhesion between the adhesive mass and the support as a function of a variation in at least one parameter of the adhesive mass.

17. The kit according to claim 16, wherein the attachment member includes two protective films that protect the adhesive mass, with the adhesive mass being inserted therebetween.

18. The kit according to claim 17, wherein the adhesion between the adhesive mass and the support is greater than an adhesion between the adhesive mass and at least one of the two protective films.

19. The kit according to claim 17, wherein the adhesion between the adhesive mass and the separation element is greater than an adhesion between the adhesive mass and at least one of the two protective films.

20. The kit according to claim 18, wherein the adhesion between the adhesive mass and the separation element is greater than an adhesion between the adhesive mass and at least one of the two protective films.

21. The kit according to claim 16, further comprising an electronic device.

22. The kit according to claim 21,
wherein the separation element adheres to an adhesion surface of the adhesive mass, at least a portion of the adhesion surface being located between the adhesive mass and the electronic device, and
wherein the electronic device is held by the adhesive mass and is inserted between the separation element and the adhesion surface of the adhesive mass.

23. The kit according to claim 22, wherein the attachment member includes a protective film for the adhesive mass, the protective film adhering to an adhesion surface of the adhesive mass that is to be positioned between the adhesive mass and the support.

24. A tyre casing comprising:
a support; and
a kit for temporary attachment of an electronic device to the support,
wherein the kit includes:
an attachment member that includes adhesive mass for attaching the electronic device to the support, and
a separation element for separating the adhesive mass from the support, the separation element being able to adhere to the adhesive mass,
wherein an adhesion between the adhesive mass and the separation element becomes greater than an adhesion between the adhesive mass and the support as a function of a variation in at least one parameter of the adhesive mass, and
wherein the adhesive mass adheres to the support.

25. The tyre casing according to claim 24, wherein the support includes an inner rubber ply.

26. A method for temporarily attaching an electronic device to a support of a tyre casing using a kit that includes an attachment member and a separation element, in which the attachment member includes an adhesive mass for attaching the electronic device to the support, in which the separation element separates the adhesive mass from the support, the separation element being able to adhere to the adhesive mass, and in which an adhesion between the adhesive mass and the separation element becomes greater than an adhesion between the adhesive mass and the support as a function of a variation in at least one parameter of the adhesive mass, the method comprising steps of:
adhering the adhesive mass to the support;
utilizing the adhesive mass to hold the electronic device;
adhering the separation element to the adhesive mass; and
altering a parameter of the adhesive mass such that an adhesion between the adhesive mass and the separation element exceeds an adhesion between the adhesive mass and the support,
wherein a unit formed of the electronic device, the adhesive mass, and the separation element is separable from the support of the tyre casing by pulling on the separation element.

27. The method according to claim 26, wherein the adhesive mass is entirely covered by the separation element.

28. The method according to claim 26, wherein the parameter is a temperature of the adhesive mass.

29. The method according to claim 27, wherein the parameter is a temperature of the adhesive mass.

30. The method according to claim 28,
wherein the adhesion between the adhesive mass and the separation element exceeds the adhesion between the adhesive mass and the support when the temperature of the adhesive mass is greater than a predetermined temperature threshold, and
wherein the temperature of the adhesive mass is kept above the predetermined temperature threshold before the unit formed of the electronic device, the adhesive mass, and the separation element is separated from the support of the tyre casing.

31. The method according to claim 29,
wherein the adhesion between the adhesive mass and the separation element exceeds the adhesion between the adhesive mass and the support when the temperature of the adhesive mass is greater than a predetermined temperature threshold, and
wherein the temperature of the adhesive mass is kept above the predetermined temperature threshold before the unit formed of the electronic device, the adhesive mass, and the separation element is separated from the support of the tyre casing.

32. A processing method for a tyre casing that includes an electronic device temporarily attached to a support of the tyre casing using a kit that includes an attachment member and a separation element, in which the attachment member includes an adhesive mass for attaching the electronic device to the support, in which the separation element separates the adhesive mass from the support, the separation element being able to adhere to the adhesive mass, and in which an adhesion between the adhesive mass and the separation element becomes greater than an adhesion between the adhesive mass and the support as a function of a variation in at least one parameter of the adhesive mass, the method comprising:
adhering the adhesive mass to the support;
utilizing the adhesive mass to hold the electronic device;
adhering the separation element to the adhesive mass; and
altering a parameter of the adhesive mass such that an adhesion between the adhesive mass and the separation element exceeds an adhesion between the adhesive mass and the support,
wherein a unit formed of the electronic device, the adhesive mass, and the separation element is separable from the support by pulling on the separation element,
wherein the step of altering the parameter of the adhesive mass is performed during a processing step, and
wherein the unit is separated from the support after the processing step.

33. The method according to claim 32,
wherein the tyre casing includes a structure and a worn tread, and
wherein the processing step includes:
removing the worn tread,
attaching a new raw tread to the structure, and
vulcanizing a unit formed of the structure and the new raw tread in a vulcanization mould.
